(19) United States
(12) Patent Application Publication
(10) Pub. No.: US 2023/0090153 A1
(43) Pub. Date: Mar. 23, 2023

(54) Wireless Fire Rate of Growth (FROG) system

(71) Applicant: Yanik Freeman, Whitehorse (CA)

(72) Inventor: Yanik Freeman, Whitehorse (CA)

(21) Appl. No.: 17/946,242

(22) Filed: Sep. 16, 2022

Related U.S. Application Data
(60) Provisional application No. 63/246,204, filed on Sep. 20, 2021.

(51) Int. Cl. B64C 39/02; A62C 37/44

(52) U.S. Cl. CPC B64C 39/024; A62C 37/44; B64C 2201/082; B64C 2201/145

(57) ABSTRACT

A method and system for determining the rate of growth of a wildfire.

### FIELD OF THE INVENTION

The invention relates to a wireless method and system for determining the rate of growth of a wildfire based on key metric signatures to determine when individual sensors are consumed.

### BACKGROUND OF THE INVENTION

Fire spread is currently mapped by flying the wildfire's perimeter with a GPS device or through satellite heat mapping. These methods work, but sometimes smoke can make flying a perimeter difficult while satellite data updates on a schedule.

Fire Rate of Growth (FROG) sensors offer real-time data on conditions at the head of an active wildfire front where it is normally too dangerous for firefighters to work. When combined with aerial observation, the system is a powerful tool for the future of firefighting and fire science in an increasingly warming world.

### BRIEF SUMMARY OF THE INVENTION

The invention consists of multiple disposable FROG sensors which transmit measurements in real-time from when they are dropped from a helicopter or other aircraft including UAV until the wildfire consumes them.

The aircraft delivering the payloads is equipped with a transceiver (rover) which communicates with the individual sensors and relays this information to a ground station or on-board computer for further processing, mapping and analysis.

### BRIEF DESCRIPTION OF THE DRAWINGS

FIG. 1 is a side view diagram detailing the FROG sensor (base).

FIG. 2 is a bottom view diagram detailing the FROG sensor (base).

FIG. 3 is a side view diagram detailing the rover.

FIG. 4 is a bottom view diagram detailing the rover.

### DETAILED DESCRIPTION OF THE INVENTION

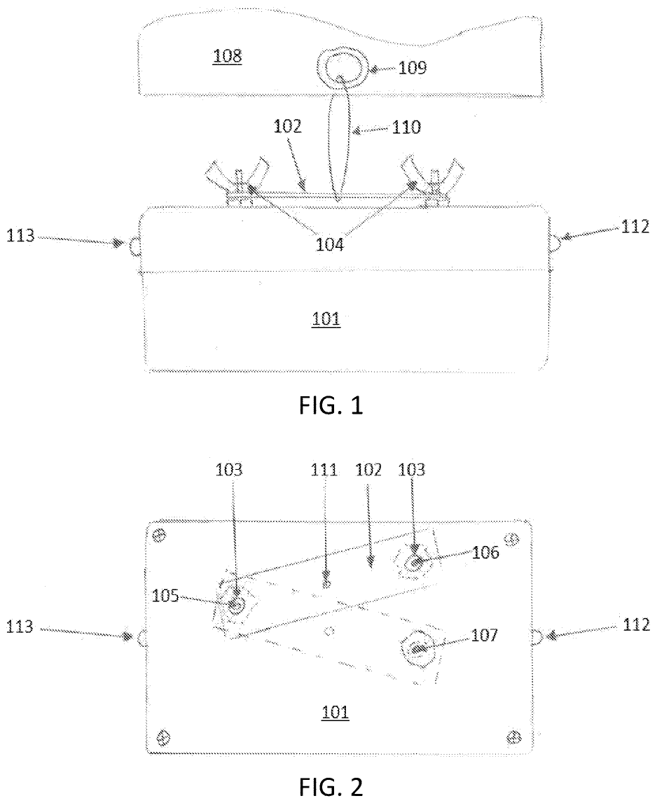

FIG. 1 and FIG. 2 illustrate a FROG sensor (base) which is designed to be disposable and is contained within a ruggedized enclosure 101. An arming bar acting as a switch consists of a flat metal plate 102 and has two holes 103 which are used to affix it to the bottom of the unit on three studs in two possible positions using two wing nuts 104. In the first position the arming bar connects the pivot stud 105 to the off stud 106. In the second position the arming bar connects the pivot stud to the on stud 107. This design reduces the possibility of a conventional switch turning itself off on impact when deployed. In order to control the speed of descent a streamer 108 with grommet 109 is attached to the arming bar using a tie 110 through a third smaller hole 111. When armed the LED light 112 mounted on one end indicates activity and powered-on state. An IR photodiode 113 mounted on the opposite end is used as a flame detector. In addition there are internal sensors for measuring metrics such as pressure, temperature, humidity and gas concentration.

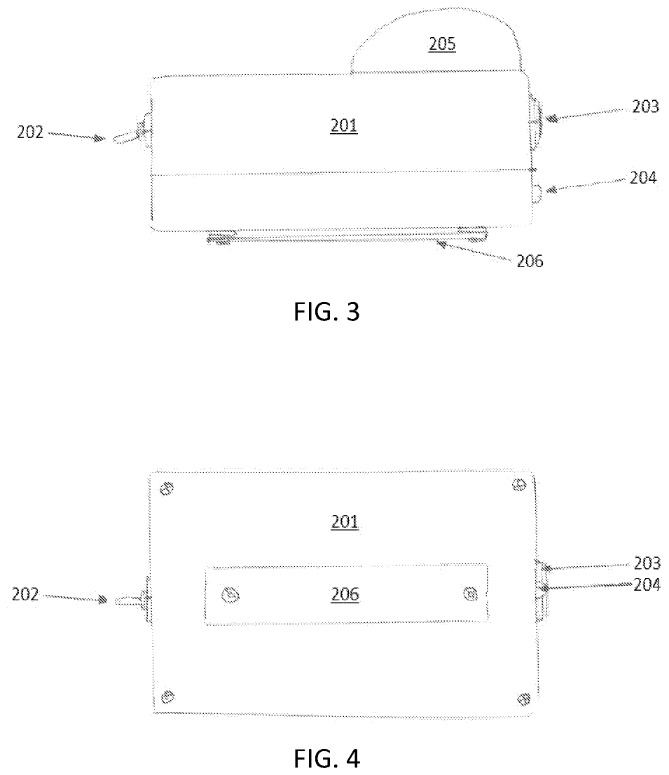

FIG. 3 and FIG. 4 illustrate a rover which is designed to be re-usable and is contained within a ruggedized enclosure 201. There is a power toggle switch 202 mounted on one end. A USB port 203 for recharging and LED light 204 to indicate activity and powered-on state are mounted on the opposite end. A GPS antenna 205 is mounted on the top of the unit. A mounting bar 206 on the underside provides a means of attaching the unit upright with a clear view of the sky to a helicopter skid or step by slotting through two pipe clamps.

Once armed and dropped in a line or fan pattern from the head of the fire the FROG sensors transmit telemetry to the rover. The GPS in the rover provides a deployment position for each drop. The base closest to the head of the wildfire is consumed first at time t1. As the fire spreads it will eventually consume the remaining deployed units and these will cease to transmit at time tn where n is the unit number. Characteristics in the data such as a spike in temperature or IR can be used to differentiate between the presence of fire as opposed to a loss of signal due to range or other factors. The rate of growth of a fire is then calculated as the distance between two units divided by (tn−t1).

1. A method for determining the rate of growth of a wildfire comprising: A) dropping a first base at the head of the fire; B) obtaining a GPS position of the base in A using the rover; C) dropping a second base some distance away in the projected path of the fire; D) obtaining a GPS position of the base in C using the rover; E) determining when the base in A is consumed by fire at time t1 by analyzing characteristics in the data such as a spike in temperature or IR; F) determining when the base in C is consumed by fire at time t2 by analyzing characteristics in the data such as a spike in temperature or IR; and G) calculating the inverse distance between positions in B and D divided by (t2−t1).

2. A disposable base system for the method in claim 1 comprising: A) a ruggedized enclosure containing sensors, control circuitry, transceiver and batteries; B) an arming bar acting as a switch; C) a streamer to control the speed of descent of the unit when dropped; D) an LED status light; and E) an IR photodiode for flame detection.

3. A reusable rover system for the method in claim 1 comprising: A) a ruggedized enclosure containing sensors, control circuitry, transceiver and batteries; B) a toggle power switch; C) a GPS antenna; D) an LED status light; E) a USB charging port; and F) a bottom mounting bar.
